(19) United States
(12) Patent Application Publication
(10) Pub. No.: US 2014/0096454 A1
(43) Pub. Date: Apr. 10, 2014

(54) METHODS AND APPARATUS FOR CLAMPING VAULT LID TO VAULT BASE TO ESTABLISH SEAL THEREBETWEEN

(71) Applicant: Batesville Services, Inc., Batesville, IN (US)

(72) Inventors: Daniel G. Meiser, Wilder, KY (US); Ilija Rojdev, Cincinnati, OH (US)

(73) Assignee: Batesville Services, Inc., Batesville, IN (US)

(21) Appl. No.: 13/789,321

(22) Filed: Mar. 7, 2013

Related U.S. Application Data
(60) Provisional application No. 61/660,338, filed on Jun. 15, 2012.

(51) Int. Cl. A61G 17/00; F16B 2/06

(52) U.S. Cl. CPC A61G 17/00; F16B 2/06
USPC 49/506; 24/458; 24/522

(57) ABSTRACT

A method of establishing a seal between a casket vault lid and a casket vault base comprises the steps of positioning a gasket between confronting generally horizontal surfaces of the lid and base, positioning a base engagement member of a clamping assembly in a recess in the base, positioning a lid engagement member of the clamping assembly in a recess in the lid, and operating the clamping assembly so as to draw the base engagement member and the lid engagement member toward one another to thereby compress the gasket between the confronting generally horizontal surfaces of the lid and base.

### RELATED APPLICATIONS

This application claims the priority benefit of U.S. Provisional Patent Application No. 61/660,338 filed Jun. 15, 2012, which is hereby incorporated by reference herein as if fully set forth in its entirety.

### FIELD OF THE INVENTION

This invention relates generally to casket vaults, and more particularly to methods and apparatus for establishing a seal between the casket vault lid and the casket vault base.

### BACKGROUND OF THE INVENTION

For above-ground or below-ground interment of the body of a deceased, the body is typically placed in a casket. The casket may be placed in a casket vault if greater protection for the casket and body is desired.

Casket vaults may be fabricated from concrete or synthetic resinous material. Earlier examples of casket vaults fabricated from synthetic resinous material are disclosed in U.S. Pat. No. 5,245,733 issued Sep. 21, 1993 for Combination Burial Vault/Casket, U.S. Pat. No. 5,321,873 issued Jun. 21, 1994 for Burial Container, and U.S. Pat. No. 6,282,763 issued Sep. 4, 2001 for Burial Container And Methods Of Making, all of which are hereby incorporated by reference herein as if fully set forth in their entirety.

More recent examples of synthetic resinous material casket vaults are disclosed in the assignee's US Patent Application Publication No. 2011/0107568 published May 12, 2011 for Casket Vault, and US Patent Application Publication No. 2012/0096693 published Apr. 26, 2012 for Vault And Vault/Casket Display, both of which are hereby incorporated by reference herein as if fully set forth in their entirety.

Recent examples of ornamental designs for casket vaults are the subject of the assignee's U.S. Design Pat. Nos. D650,965 issued Dec. 20, 2011 for Vault and U.S. Design Pat. No. D662,685 issued Jun. 26, 2012 for Vault, both of which are hereby incorporated by reference herein as if fully set forth in their entirety.

A common feature of most current casket vaults is the provision of gasket material, typically butyl, between the vault lid and the vault base, whether the vault is of concrete construction or synthetic resinous material construction. In a concrete vault, bolts or the like are typically not used to secure the lid to the base. Rather, the weight of the lid itself is relied upon to retain the lid securely on the base. The weight of the lid also compresses the gasket material between the lid and the base so as to aid or assist in partially or completely causing the gasket material to “set,” which is generally desirable for effecting good sealing between the lid and base.

Some current synthetic resinous material casket vaults employ the use of bolts to secure the vault lid to the vault base. For those vaults, sufficiently tightening the bolts to securely retain the lid on the base also typically adequately compresses the gasket material between the lid and the base so as to aid or assist in partially or completely causing the gasket material to set and effect good sealing between the lid and base.

However, not all synthetic resinous material casket vaults employ the use of bolts to secure the vault lid to the vault base. In those vaults, due to the lightweight nature of the synthetic resinous material, the weight of the vault lid is typically insufficient to adequately compress the gasket material between the lid and the base so as to cause the gasket material to completely or even partially set.

Accordingly, methods and apparatus are desired for clamping a casket vault lid to a casket vault base in order to adequately compress the gasket material so as to aid or assist in partially or completely causing the gasket material to set, thereby initiating the seal therebetween.

### SUMMARY OF THE INVENTION

In one aspect, a method of establishing a seal between a casket vault lid and a casket vault base is provided. The method comprises the steps of positioning a gasket between confronting generally horizontal surfaces of the lid and base, positioning a base engagement member of a clamping assembly in a recess in the base, positioning a lid engagement member of the clamping assembly in a recess in the lid, and operating the clamping assembly so as to draw the base engagement member and the lid engagement member toward one another to thereby compress the gasket between the confronting generally horizontal surfaces of the lid and base.

The method can further comprise the steps of positioning a first base engagement member on one side of the vault and positioning a second base engagement member on the other side of the vault, each base engagement member positioned in a recess in a respective side of the base, positioning a first lid engagement member on one side of the vault and positioning a second lid engagement member on the other side of the vault, each lid engagement member positioned in a recess in a respective side of the lid, and operating the clamping assembly so as to draw the base engagement members and the lid engagement members toward one another to thereby compress the gasket between the confronting generally horizontal surfaces of the lid and base simultaneously on both sides of the vault. The step of positioning the gasket between confronting generally horizontal surfaces of the lid and base can comprise placing the gasket in a downwardly facing groove of the lid and then placing the lid on the base.

In another aspect, a clamping assembly for clamping a casket vault lid to a casket vault base is provided. The clamping assembly comprises a clamp support, a clamp lever pivotally connected to the clamp support, a lid engagement member, adapted to be received in a recess in the lid, on either the clamp support or the clamp lever, and a base engagement member, adapted to be received in a recess in the base, on the other of the clamp support and the clamp lever. Pivoting the clamp lever effects relative movement between the base engagement member and the lid engagement member to draw the base engagement member and the lid engagement member toward one another to thereby draw confronting generally horizontal surfaces of the lid and base toward one another.

In one embodiment, the clamp support is an angle bracket, the lid engagement member is connected to an end of one leg of the angle bracket, an end of the other leg of the angle bracket is adapted to be supported on the lid at a location above and inward from the lid engagement member, the lever is pivotally connected to the other leg of the angle bracket, and the base engagement member is connected to the lever. The angle bracket can be a channel section, the base engagement member can be connected to the lever via a band having a dog leg therein, and the dog leg can pass between a pair of vertically spaced posts spanning between side walls of the channel section.

In another embodiment, the lever is pivotally connected to the clamp support on one side of the clamp support, the base engagement member is connected to the clamp support on the other side of the clamp support, and the lid engagement member is connected to the lever.

In yet another embodiment, the lever is pivotally connected to the clamp support on one side of the clamp support, the lid engagement member is connected to the clamp support on the other side of the clamp support, and the base engagement member is connected to the lever.

In another aspect, a clamping assembly for clamping a casket vault lid and a casket vault base. The clamping assembly comprises a first clamp frame having a first frame member adapted to be positioned on one side of the vault and a second frame member adapted to be positioned on the other side of the vault, each of the frame members having a lid engagement member adapted to be received in a recess in a respective side of the lid, a second clamp frame having a first frame member adapted to be positioned on one side of the vault and a second frame member adapted to be positioned on the other side of the vault, each of the frame members having a base engagement member adapted to be received in a recess in a respective side of the base, and a mechanism for effecting relative movement between the first clamp frame and the second clamp frame and thus between the base engagement members and the lid engagement members to draw the base engagement members and the lid engagement members toward one another to thereby draw confronting generally horizontal surfaces of the lid and base toward one another simultaneously on both sides of the vault.

The first clamp frame can further comprise a generally vertically oriented tube connected to the first and second frame members of the first clamp frame generally medially of a transverse extent of the first clamp frame, and the second clamp frame can further comprise a generally vertically oriented rod connected to the first and second frame members of the second clamp frame generally medially of a transverse extent of the second clamp frame, the rod extending through the tube. The mechanism is operable to move the rod upwardly relative to the tube.

The first frame member of the second clamp frame can ride in a slot in the first frame member of the first clamp frame, and similarly the second frame member of the second clamp frame can ride in a slot in the second frame member of the first clamp frame. Each of the first and second frame members of the second clamp frame can be connected to a draw link on an upper end of the draw link and the base engagement member can be on a lower end of the draw link. Each draw link can have a dog leg therein. Each of the first and second frame members of the first clamp frame can have an L-shaped slot in a lower end thereof and a cylindrical rolling element disposed in the slot. Each dog leg of each draw link can be disposed below a respective one of the cylindrical rolling elements in a respective one of the first and second frame members of the first clamp frame. The mechanism can comprise in one embodiment a lever pivotally connected to either the tube or the rod and operable relative to the other of the tube and the rod. In another embodiment, the mechanism can comprise a threaded block on an upper end of the tube, threads on an upper end of the rod, and a handle on an upper end of the rod; rotating the handle causes the threaded end of the rod to move upwardly relative to the threaded block on the tube.

In another aspect, a method of clamping a casket vault lid and a casket vault base is provided. The method comprises positioning the casket vault lid on the casket vault base, positioning a base engagement member of a clamping assembly in a recess in the base, positioning a lid engagement member of the clamping assembly in a recess in the lid, and operating the clamping assembly so as to draw the base engagement member and the lid engagement member toward one another to thereby draw confronting generally horizontal surfaces of the lid and base toward one another.

The method can further comprise the steps of positioning a first base engagement member on one side of the vault and positioning a second base engagement member on the other side of the vault, each base engagement member positioned in a recess in a respective side of the base, positioning a first lid engagement member on one side of the vault and positioning a second lid engagement member on the other side of the vault, each lid engagement member positioned in a recess in a respective side of the lid, and operating the clamping assembly so as to draw the base engagement members and the lid engagement members toward one another to thereby draw the confronting generally horizontal surfaces of the lid and base toward one another simultaneously on both sides of the vault.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a perspective view of a casket vault according to the principles of the present invention.

FIG. 2 is a transverse cross-sectional perspective view of the casket vault of FIG. 1 along with one embodiment of a vault lid/base clamping assembly.

FIGS. 3A-3C are enlarged transverse cross-sectional views of the clamping assembly of FIG. 2 in use.

FIGS. 4A-4C are enlarged transverse cross-sectional views of another embodiment of clamping assembly in use.

FIGS. 5A and 5B are enlarged perspective and transverse cross-sectional views, respectively, of another embodiment of clamping assembly in use.

FIG. 6 is a perspective view of the casket vault of FIG. 1 with another embodiment of clamping assembly in use.

FIG. 7 is an end view of the vault and clamping assembly of FIG. 6 in use.

FIG. 8 is an enlarged perspective view of the clamping assembly of FIG. 6.

FIGS. 9A and 9B are enlarged transverse cross-sectional views of a portion of the clamping assembly of FIG. 6 in use.

### DETAILED DESCRIPTION OF THE DRAWINGS

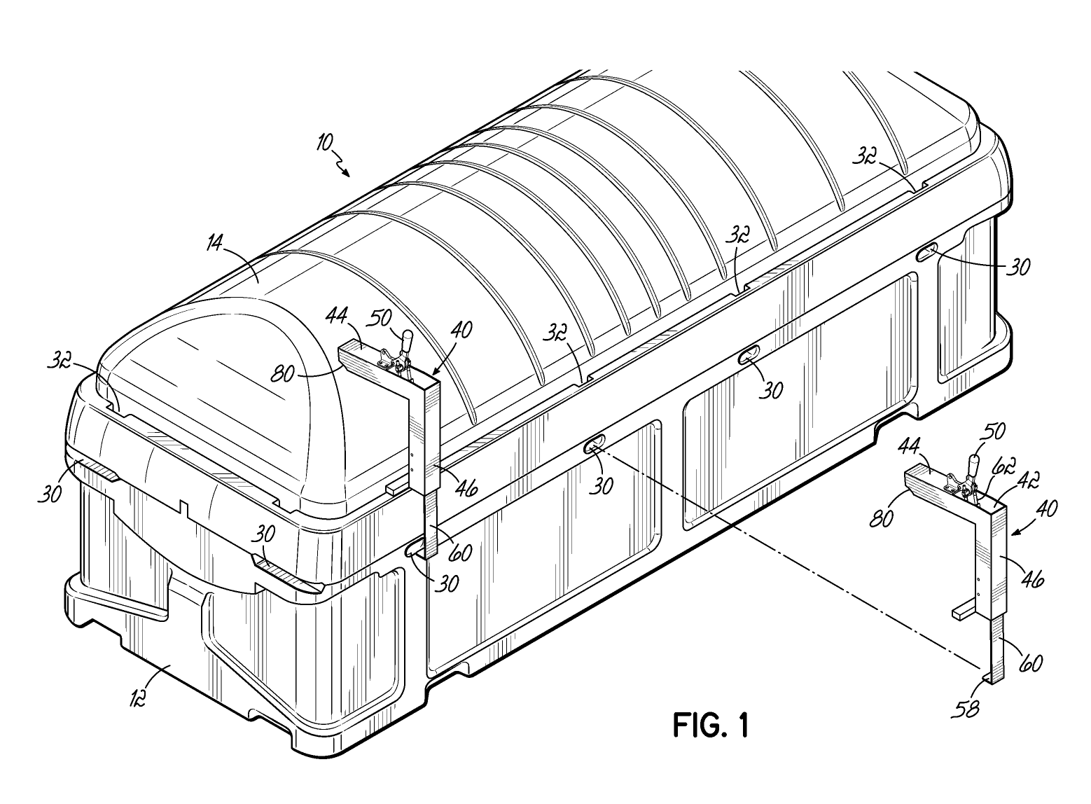

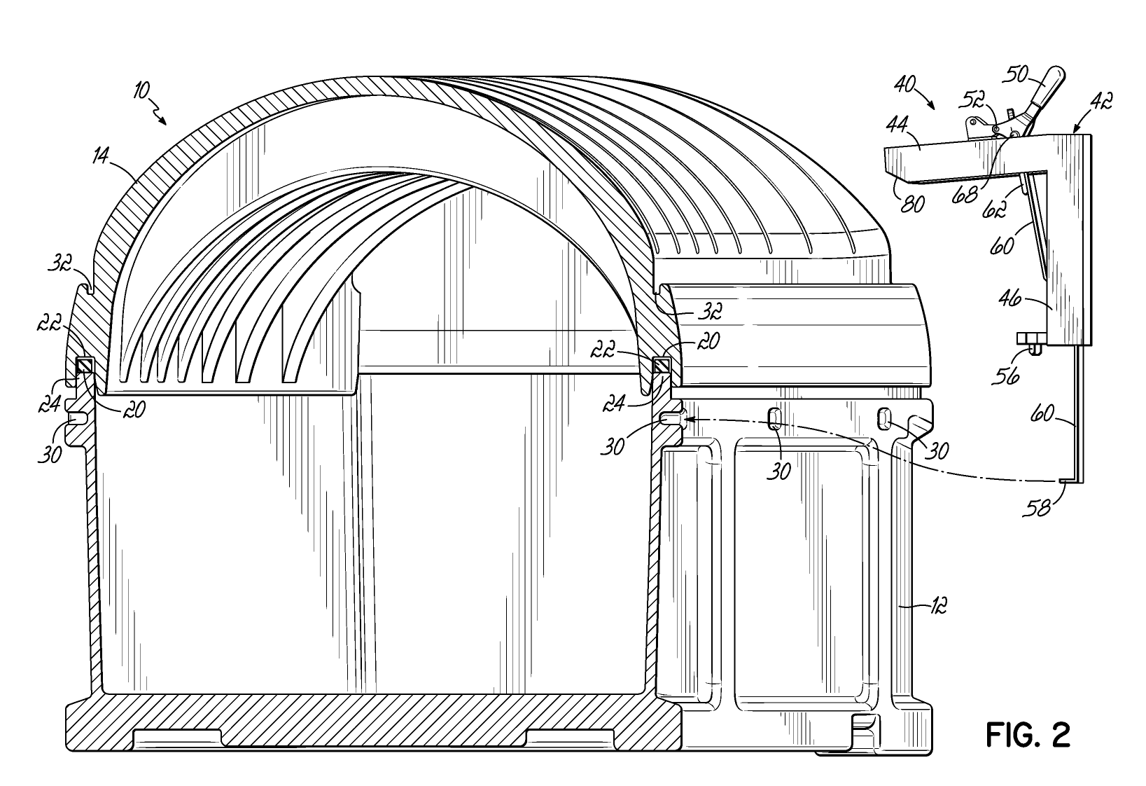

Referring first to FIGS. 1 and 2, a casket vault 10 has a vault base 12 adapted to receive a casket therein and a vault lid 14 closable on the base 12. Lid 14 has a downwardly facing groove 20 therein around a perimeter thereof in which is placed a butyl gasket 22. An upwardly facing lip or ledge 24 on the base 12 around a perimeter thereof is received in the groove 20 when the lid 14 is placed on the base 12. Recesses 30, 32 are provided in the base 12 and lid 14, respectively, the purpose for which will be subsequently described. Note that while recesses 30, 32 are illustrated as being discrete recesses or pockets, it is to be understood that the term “recess” also embraces a continuous recess or groove. Accordingly, as used herein, “recess” shall generically embrace both continuous recesses or grooves as well as discrete recesses or pockets.

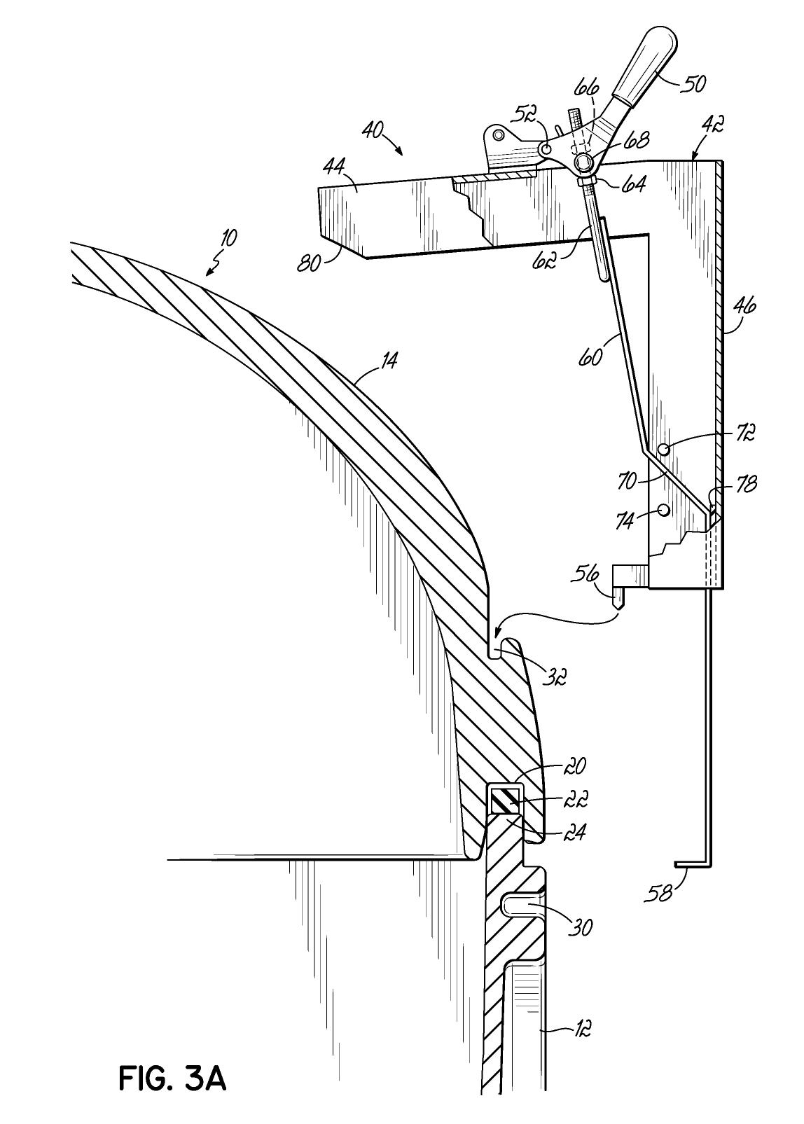

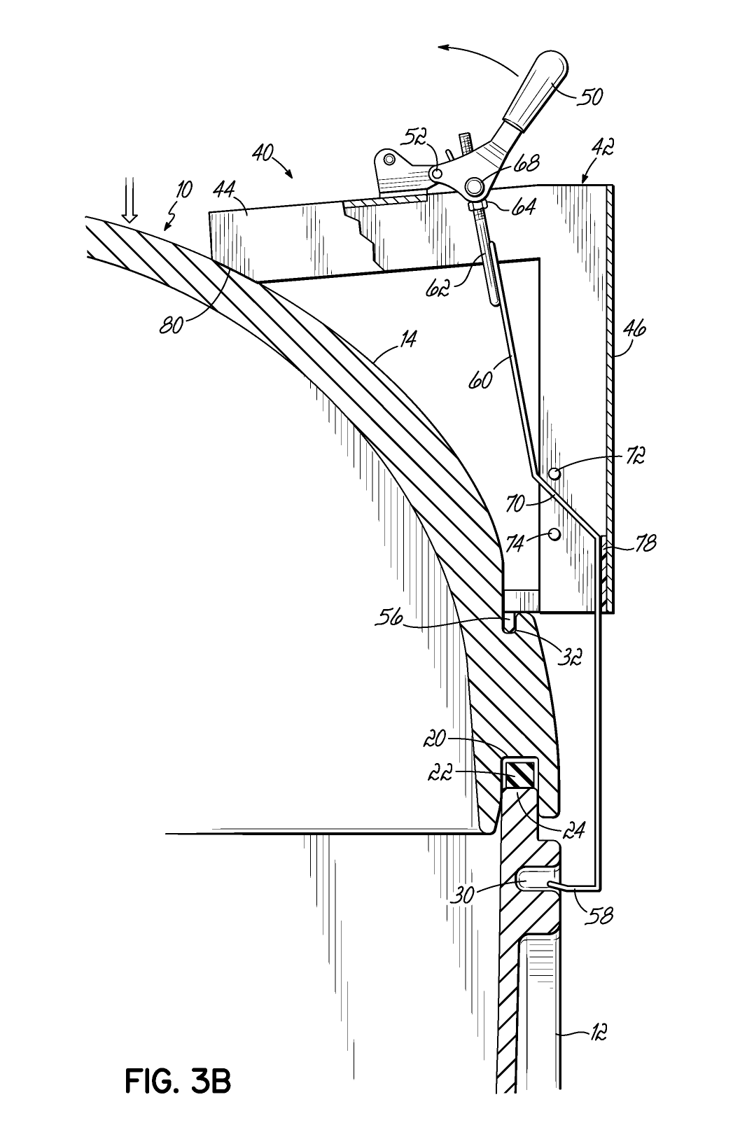

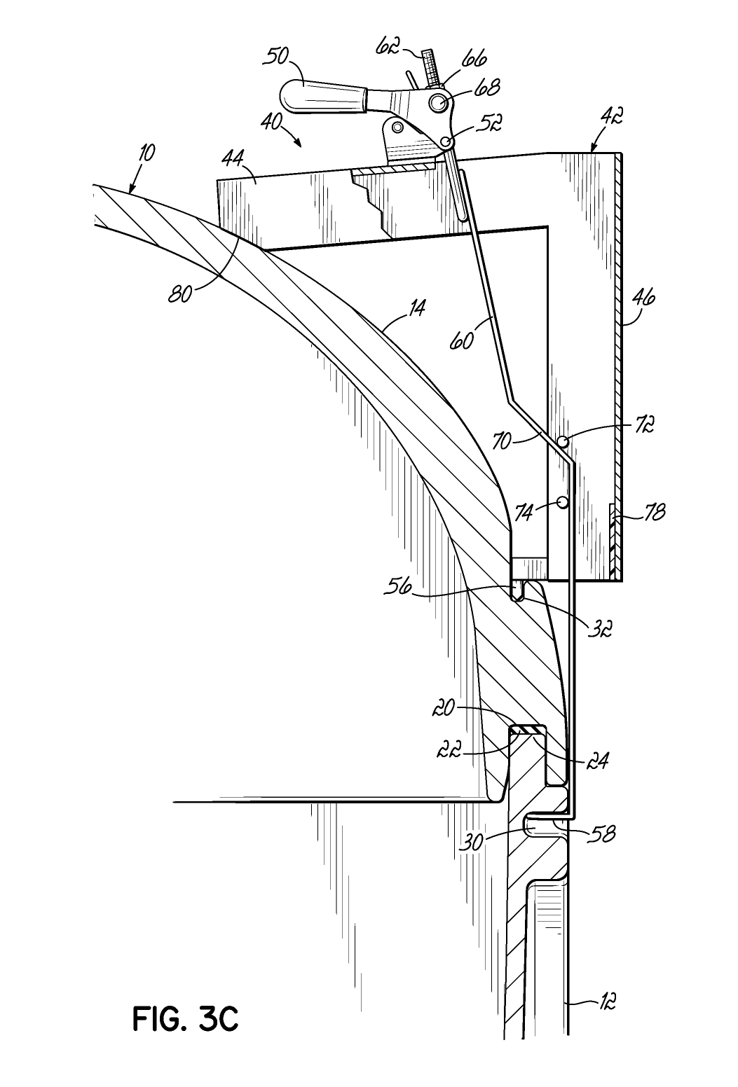

Referring now to FIGS. 3A-3C, there is illustrated one embodiment of a clamping assembly 40 for clamping the lid 14 onto the base 12 to set the butyl gasket 22. Clamping assembly 40 includes a clamp support in the form of an angle bracket 42, fabricated of steel or aluminum, for example, generally C-shaped in cross-section, having legs 44 and 46. A clamp lever 50 is pivotally connected to leg 44 of angle bracket 42 at 52 generally medially of the length of leg 44. The end of leg 46 of angle bracket 42 carries a lid engagement member 56, which is sized and configured to fit in lid recess 32. A base engagement member 58, which is sized and configured to fit in base recess 30, is carried by a draw link or band or element 60 (for example, spring steel band) connected to an adjustment U-bolt 62. The ends of adjustment U-bolt 62 pass through holes in pin 68 that is connected to lever 50. Adjustment U-bolt 62 is threaded at its ends each of which carries adjustment nuts 64, 66 for adjusting the throw of lever 50. Draw link 60 has a dog leg 70 formed therein that passes through a pair of guide posts 72, 74 connected between the side walls of the C-section angle bracket 42. Dog leg 70 and guide posts 72, 74 generate inward motion of base engagement member 58 during upward motion of base engagement member 58 caused by pivoting of clamp lever 50 to the clamped position. The end of leg 44 of angle bracket 42 is beveled at 80 for placement on top of the lid 14 so as to support the angle bracket 42 during use. Finally, a bearing 78, for example strip of low friction plastic, is attached to the interior surface of the web of the C-section angle bracket 42 at its lower end to reduce the sliding friction of draw link 60 against the angle bracket.

Use of the clamping assembly 40 is as follows. Butyl gasket material 22 is loaded into groove 20 in lid 14, and lid 14 is placed on base 12. Then a suitable number of clamping assemblies 40, for example four or more, are positioned around vault 10. The lid engagement members 56 are positioned in lid recesses 32 and the base engagement members 58 are placed in the base recesses 30. Then the levers 50 are pivoted so as to draw the engagement members toward one another, and in the process compressing the butyl gasket material 22. Clamping assemblies 40 are left clamped on vault 10 for a sufficient amount of time for the butyl material to set so as to initiate or establish sealing between the base 12 and lid 14, for example about five minutes or so, and then removed. As used herein, the terms “causing the gasket material to set,” “initiating a seal,” “establishing a seal,” and the like shall be deemed to be interchangeable.

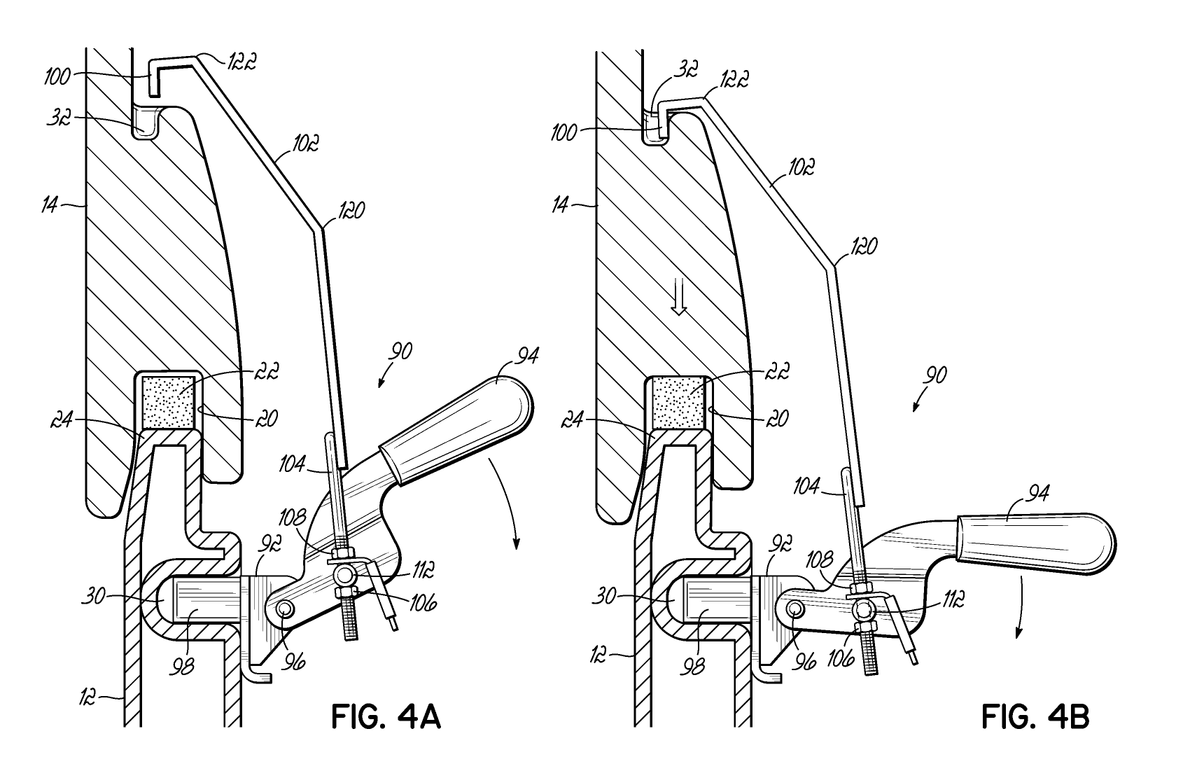

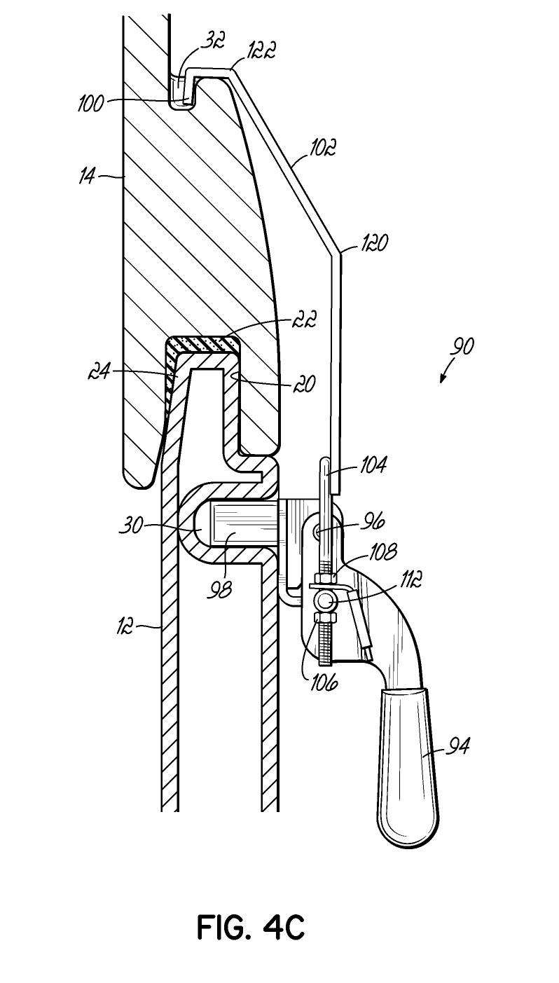

Referring now to FIGS. 4A-C, there is illustrated another embodiment of a clamping assembly 90 for clamping the lid 14 onto the base 12 to set the butyl gasket 22. Clamping assembly 90 includes a clamp support 92, a clamp lever 94 pivotally connected to the clamp support 92 on one side at 96, and a base engagement member 98, which is sized and configured to fit in base recess 30, on the other side of clamp support 92. Similar to base engagement member of the prior embodiment, a lid engagement member 100, which is sized and configured to fit in lid recess 32, is carried by a draw link or band or element 102 (for example, spring steel band) connected to an adjustment U-bolt 104. The ends of adjustment U-bolt 104 pass through holes in pin 112 that is connected to lever 94. Adjustment U-bolt 104 is threaded at its ends and carries adjustment nuts 106, 108 for adjusting the throw of lever 94. Draw link 102 includes a pair of bends 120, 122 to reach from U-bolt 104 to lid recess 32.

The use of clamping assemblies 90 is substantially the same as the use of clamping assemblies 40 described above.

Note that by reconfiguring the base engagement member 98 so as to be able to engage the lid recess 32, and by reconfiguring the lid engagement member 100 so as to be able to engage the base recess 30, the assembly 90 can essentially be flipped end-to-end and used in that orientation. In other words, the base engagement member would become the lid engagement member, and the lid engagement member would become the base engagement member.

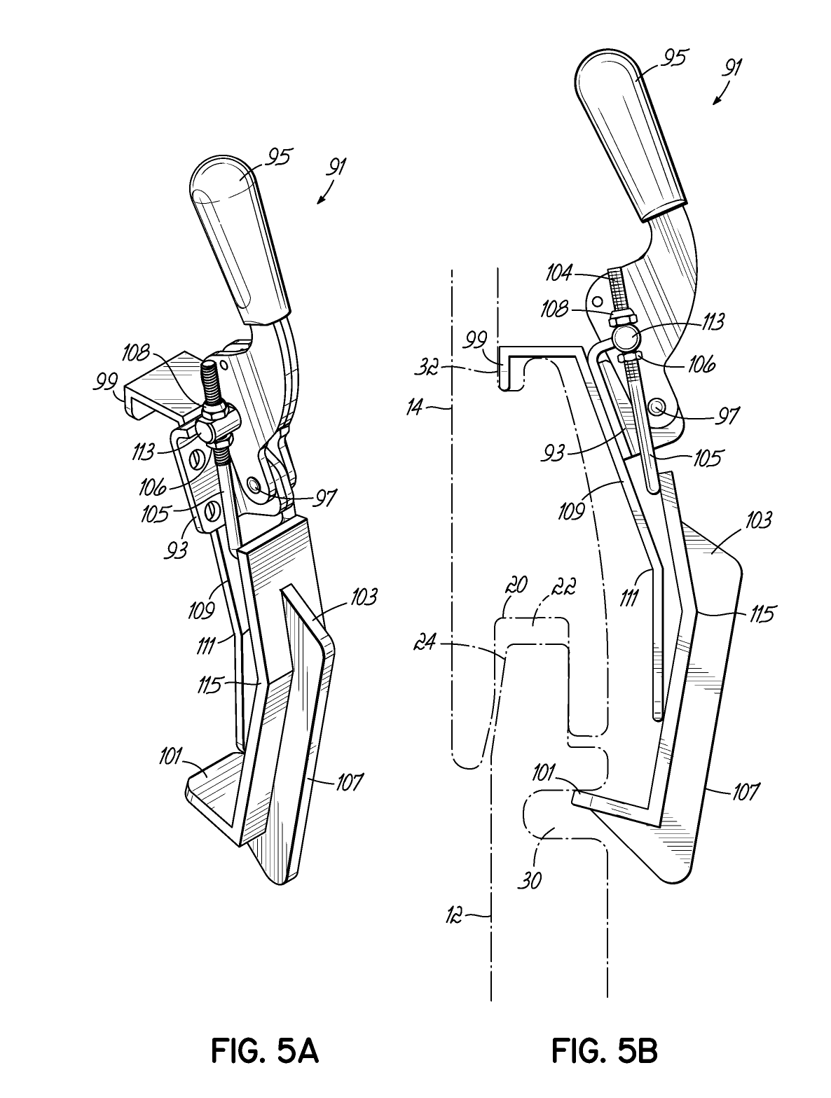

To that end, and referring to FIGS. 5A and 5B, there is illustrated another embodiment of a clamping assembly 91 for clamping the lid 14 onto the base 12 to set the butyl gasket 22. Clamping assembly 91 includes a clamp support 93, a clamp lever 95 pivotally connected to the clamp support 93 on one side at 97, and a lid engagement member 99, which is sized and configured to fit in lid recess 32, on the other side of clamp support 93. A base engagement member 101, which is sized and configured to fit in base recess 30, is carried by a draw link or band or element 103 connected to an adjustment U-bolt 105. The ends of adjustment U-bolt 105 pass through holes in pin 113 that is connected to lever 95. Adjustment U-bolt 105 is threaded at its ends and carries adjustment nuts 106, 108 for adjusting the throw of lever 95. Draw link 103 includes a bend at 115 and a stiffening gusset 107. Lid engagement member 99 includes an extension 109 with bend 111 therein such that lid engagement member 99 and draw link 103 overlap.

The use of clamping assembly 91 is substantially the same as the use of clamping assemblies 40 and 90 described above.

One source for commercially available toggle clamps for use as a starting point in fabricating the clamping assemblies 40, 90, and 91 is DE-STA-CO, 1025 Doris Road, Auburn Hills, Mich. 48326. See, for example, DE-STA-CO manual toggle clamps at http://www.destaco.com/manual-clamps.html.

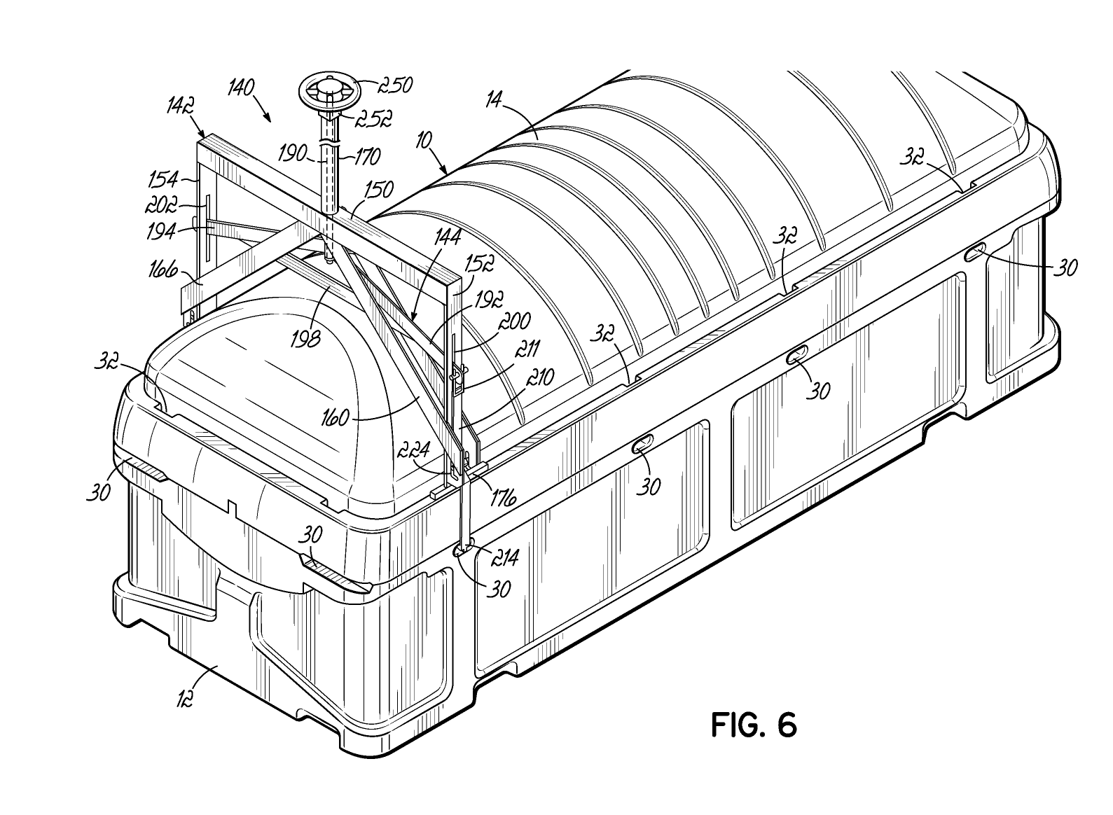

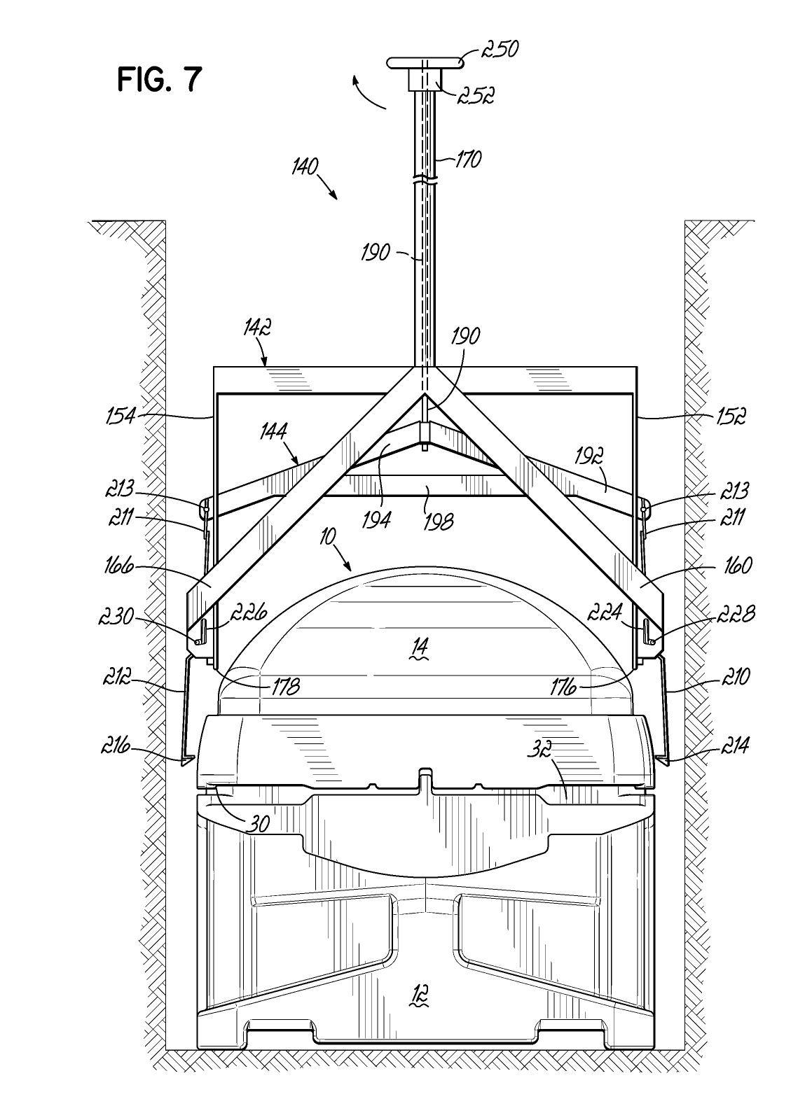

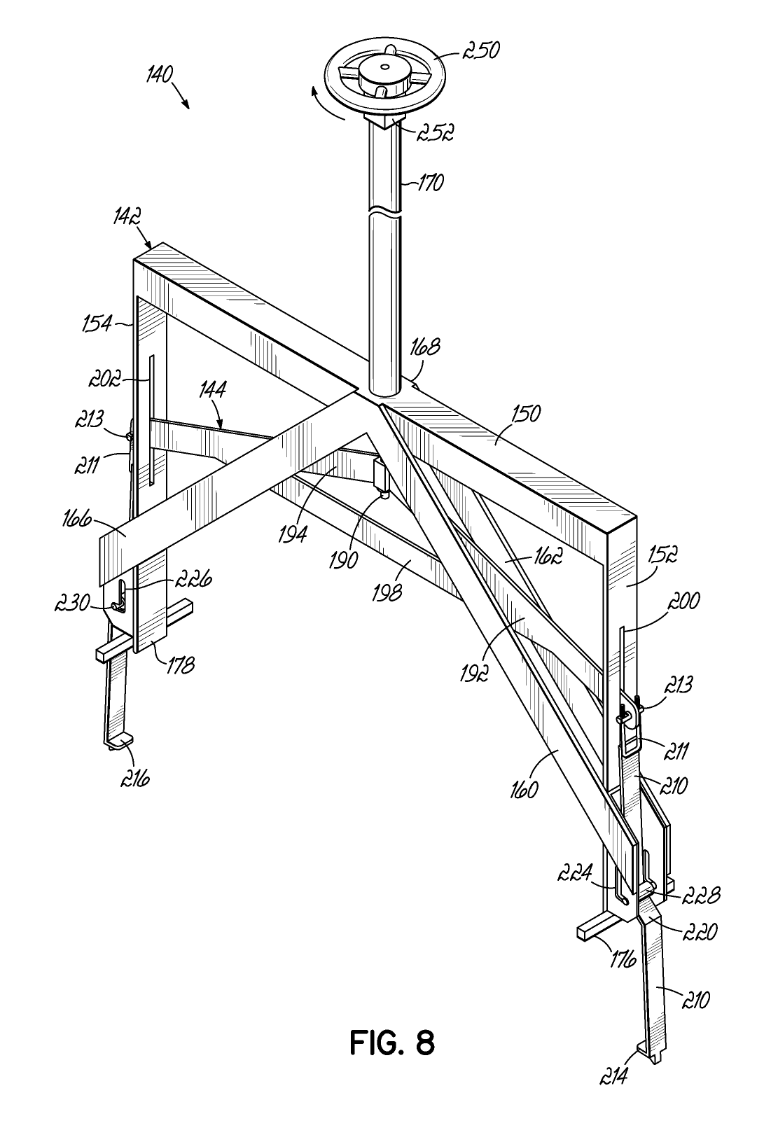

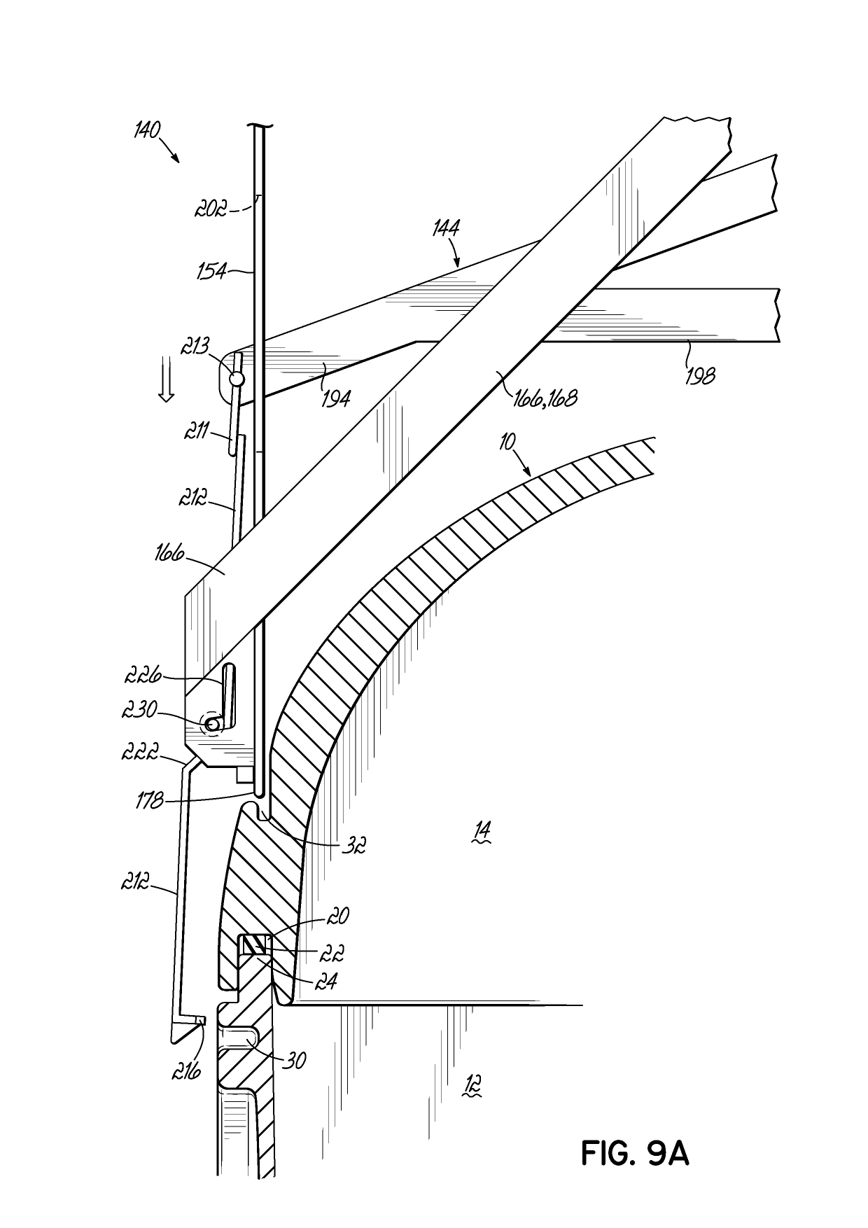

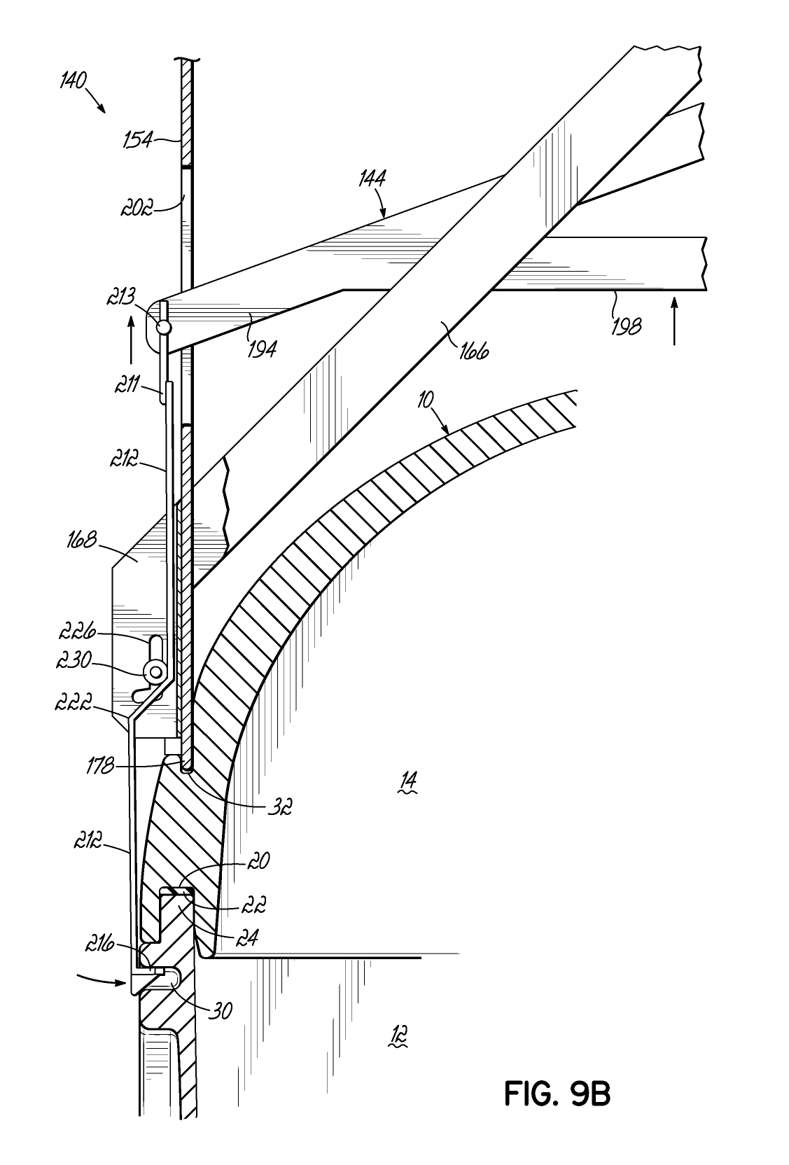

Referring now to FIGS. 6-9A, there is illustrated another embodiment of a clamping assembly 140 for clamping the lid 14 onto the base 12 to set the butyl gasket 22. The clamping assembly 140 is particularly suited for so-called “set in” services. In a set in service, the empty vault base is lowered into the grave, the casket is lowered into the vault base, and then the vault lid with butyl seal in place is lowered onto the base. This places the top of the vault lid around eighteen inches or so below ground level (and the interface of vault lid to vault base even lower), thus making use of the prior embodiments of clamping assemblies problematic. The clamping assembly 140 provides a convenient means of setting the butyl in such a service.

Clamping assembly 140 has a first clamp frame 142 and a second clamp frame 144. First clamp frame 142 has a generally horizontally oriented frame member 150 and a pair of generally vertically oriented frame members 152, 154, positioned on opposite sides of the vault 10 and extending downwardly from respective ends of the frame member 150. Brace frame members 160, 162 connect the lower end of frame member 152 to frame member 150 near a middle of the frame member 150. Similarly, brace frame members 166, 168 connect the lower end of frame member 154 to frame member 150 also near a middle of the frame member 150. A generally vertically oriented hollow tube 170 is connected to frame member 150 also near a middle of the frame member 150. The lower ends of frame members 152, 154 carry respective lid engagement members 176, 178, each sized and configured to fit in lid recess 32.

Second clamp frame 144 has a rod 190 passing downwardly through tube 170 of first clamp frame 144 and rotatably connected on its lower end to a pair of frame members 192, 194 that angle downwardly and outwardly from the lower end of the rod 190 and that are interconnected by a frame member 198. The end of frame member 192 extends through a slot 200 in frame member 152 and similarly the end of frame member 194 extends through a slot 202 in frame member 154. The end of frame member 192 is connected to the upper end of a draw link or band or element 210 and the end of frame member 194 is similarly connected to the upper end of a draw link or band or element 212. As in prior embodiments, the draw links 210, 212 are connected to their respective frame members 192, 194 with U-bolts 211 and pins 213. The lower ends of the draw links 210, 212 carry respective base engagement members 214, 216, each sized and configured to fit in base recess 30.

Similar to the first embodiment described above, draw link 210 includes a dog leg 220 and draw link 212 includes a dog leg 222. The lower end of frame member 152 carries an L-shaped slot 224 and similarly the lower end of frame member 154 carries an L-shaped slot 226. A cylindrical rolling element 228 rides in slot 224 and similarly a cylindrical rolling element 230 rides in slot 226. Similar to the first embodiment described above, the camming action of the dog legs 220, 222 of the draw links 210, 212 riding against cylindrical rolling elements 228, 230 riding in slots 224, 226 generates inward motion of base engagement members 214, 216 during upward motion of base engagement members 214, 216 caused by upward movement of rod 190, as described below.

As can be appreciated from FIGS. 6-9A, upward motion of rod 190 relative to tube 170 draws the lid and base engagement members toward one another, and in the process compressing the butyl gasket material 22. Any number of mechanisms may be utilized to generate the upward motion of the rod 190 relative to the tube 170. For example, a pivoting lever of the type described above used in the clamping assemblies 40, 90, and 91 could be used. As another example, the tube 170 could carry a threaded block 252 rotatably fixed to the upper end of the tube 170. An upper portion of rod 190 could be mateably threaded and threadably received in the threaded block 252. Finally, the rod 190 could carry a handle 250 rotatably fixed to the upper end of the rod 190, the rotation of which would cause the threaded upper portion of the rod to move upwardly relative to the threaded block and hence the tube, the result being to draw the engagement members toward one another, and in the process compressing the butyl gasket material 22.

In use of this embodiment of clamping assembly 140, a single assembly is, or two or more such assemblies are, lowered onto the vault 10. The lid engagement members 176, 178 are positioned in lid recesses 32, which places the base engagement members 214, 216 generally at the same height as the base recesses 30 but not yet engaged with those recesses. Then either the lever is pivoted or the handle is rotated, as described above, to draw the base engagement members 214, 216 inwardly so as to engage base recesses 30 and to draw the base engagement members 214, 216 and lid engagement members 176, 178 toward one another. Clamping assemblies 140 are left clamped on vault 10 for a sufficient amount of time for the butyl material to set, for example about five minutes or so, and then removed. If a single such clamping assembly 140 is used, it will need to be applied to the vault 10 progressively along its length (for example at four locations along the length of the vault) to cause the butyl material to properly set.

A common feature of all the clamping assemblies 40, 90, 91, and 140 is that they are all structured, arranged, or otherwise configured to engage the base, extend from the base, reach around the interface (confronting flanges) of the base and lid, extend to the lid, engage the lid, and apply clamping force to the base and lid along a load path that extends substantially through the interface of the base and lid. The lid and base recesses being positioned inwardly relative to an outward most surface of the interface of the base and lid, precludes the use of the most efficient type of clamping assembly, one that extends in a straight line from the base recess to the lid recess. The various configurations of the clamping assemblies 40, 90, 91, and 140 are able to overcome the design challenges that the geometry of a casket vault presents.

Note that not all synthetic resinous material casket vaults employ the use of gasket material between the lid and the base, and so for those vaults there is no need to clamp the lid to the base to set a seal. However, when placing the vault in the grave, it is desirable to avoid dislodging the lid from the base in order to prevent soil from falling into the base. The embodiments of the inventions herein provide a convenient means of retaining the vault lid securely on the vault base during placement of the vault into the grave and prior to back filling the grave, whether the vault employs the use of gasket material or not.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. Accordingly, the scope of the invention shall be limited only by the following claims and their equivalents.

What is claimed is:

1. A method of establishing a seal between a casket vault lid and a casket vault base comprising the steps of:
positioning a gasket between confronting generally horizontal surfaces of the lid and base,
positioning a base engagement member of a clamping assembly in a recess in the base,
positioning a lid engagement member of the clamping assembly in a recess in the lid, and
operating the clamping assembly so as to draw the base engagement member and the lid engagement member toward one another to thereby compress the gasket between the confronting generally horizontal surfaces of the lid and base.

2. The method of claim 1 further comprising:
positioning a first base engagement member on one side of the vault and positioning a second base engagement member on the other side of the vault, each base engagement member positioned in a recess in a respective side of the base,
positioning a first lid engagement member on one side of the vault and positioning a second lid engagement member on the other side of the vault, each lid engagement member positioned in a recess in a respective side of the lid, and
operating the clamping assembly so as to draw the base engagement members and the lid engagement members toward one another to thereby compress the gasket between the confronting generally horizontal surfaces of the lid and base simultaneously on both sides of the vault.

3. The method of claim 1 wherein the step of positioning the gasket between confronting generally horizontal surfaces of the lid and base comprises placing the gasket in a downwardly facing groove of the lid and then placing the lid on the base.

4. A clamping assembly for clamping a casket vault lid and a casket vault base, said clamping assembly comprising:
a clamp support,
a clamp lever pivotally connected to said clamp support,
a lid engagement member, adapted to be received in a recess in the lid, on one of said clamp support and said clamp lever, and
a base engagement member, adapted to be received in a recess in the base, on the other of said clamp support and said clamp lever,
whereby pivoting said clamp lever effects relative movement between said base engagement member and said lid engagement member to draw said base engagement member and said lid engagement member toward one another to thereby draw confronting generally horizontal surfaces of the lid and base toward one another.

5. The clamping assembly of claim 4 further comprising:
said clamp support is an angle bracket,
said lid engagement member is connected to an end of one leg of said angle bracket,
an end of the other leg of said angle bracket is adapted to be supported on the lid at a location above and inward from said lid engagement member,
said lever is pivotally connected to the other leg of said angle bracket, and
said base engagement member is connected to said lever.

6. The clamping assembly of claim 5 wherein said angle bracket is a channel section, said base engagement member is connected to said lever via a band having a dog leg therein, and said dog leg passes between a pair of vertically spaced posts spanning between side walls of said channel section.

7. The clamping assembly of claim 4 further comprising:
said lever is pivotally connected to said clamp support on one side of said clamp support, said base engagement member is connected to said clamp support on the other side of said clamp support, and
said lid engagement member is connected to said lever.

8. The clamping assembly of claim 4 further comprising:
said lever is pivotally connected to said clamp support on one side of said clamp support, said lid engagement member is connected to said clamp support on the other side of said clamp support, and
said base engagement member is connected to said lever.

9. A clamping assembly for clamping a casket vault lid and a casket vault base, said clamping assembly comprising:
a first clamp frame having a first frame member adapted to be positioned on one side of the vault and a second frame member adapted to be positioned on the other side of the vault, each of said frame members having a lid engagement member adapted to be received in a recess in a respective side of the lid,
a second clamp frame having a first frame member adapted to be positioned on one side of the vault and a second frame member adapted to be positioned on the other side of the vault, each of said frame members having a base engagement member adapted to be received in a recess in a respective side of the base, and
a mechanism for effecting relative movement between said first clamp frame and said second clamp frame and thus between said base engagement members and said lid engagement members to draw said base engagement members and said lid engagement members toward one another to thereby draw confronting generally horizontal surfaces of the lid and base toward one another simultaneously on both sides of the vault.

10. The clamping assembly of claim 9 wherein:
said first clamp frame further comprises a generally vertically oriented tube connected to said first and second frame members of said first clamp frame generally medially of a transverse extent of said first clamp frame, and
said second clamp frame further comprises a generally vertically oriented rod connected to said first and second frame members of said second clamp frame generally medially of a transverse extent of said second clamp frame, said rod extending through said tube,
said mechanism operable to move said rod upwardly relative to said tube.

11. The clamping assembly of claim 9 wherein said first frame member of said second clamp frame rides in a slot in said first frame member of said first clamp frame, and wherein said second frame member of said second clamp frame rides in a slot in said second frame member of said first clamp frame.

12. The clamping assembly of claim 9 wherein each of said first and second frame members of said second clamp frame is connected to a draw link on an upper end of the draw link and said base engagement member is on a lower end of said draw link, each said draw link having a dog leg therein, and each of said first and second frame members of said first clamp frame having an L-shaped slot in a lower end thereof and a cylindrical rolling element disposed in said slot, each said dog leg of each said draw link disposed below a respective one of said cylindrical rolling elements in a respective one of said first and second frame members of said first clamp frame.

13. The clamping assembly of claim 10 wherein said mechanism comprises a lever pivotally connected to one of said tube and said rod and operable relative to the other of said tube and said rod.

14. The clamping assembly of claim 10 wherein said mechanism comprises:
a threaded block on an upper end of said tube,
threads on an upper end of said rod, and
a handle on an upper end of said rod,
whereby rotating said handle causes said threaded end of said rod to move upwardly relative to said threaded block on said tube.

15. A method of clamping a casket vault lid and a casket vault base comprising the steps of:
positioning the casket vault lid on the casket vault base,
positioning a base engagement member of a clamping assembly in a recess in the base,
positioning a lid engagement member of the clamping assembly in a recess in the lid, and
operating the clamping assembly so as to draw the base engagement member and the lid engagement member toward one another to thereby draw confronting generally horizontal surfaces of the lid and base toward one another.

16. The method of claim 15 further comprising:
positioning a first base engagement member on one side of the vault and positioning a second base engagement member on the other side of the vault, each base engagement member positioned in a recess in a respective side of the base,
positioning a first lid engagement member on one side of the vault and positioning a second lid engagement member on the other side of the vault, each lid engagement member positioned in a recess in a respective side of the lid, and
operating the clamping assembly so as to draw the base engagement members and the lid engagement members toward one another to thereby draw the confronting generally horizontal surfaces of the lid and base toward one another simultaneously on both sides of the vault.
